(19) United States
(12) Patent Application Publication
(10) Pub. No.: US 2009/0051290 A1
(43) Pub. Date: Feb. 26, 2009

(54) Plasma display panel

(76) Inventor: Jung-Suk Song, Suwon-si (KR)

Correspondence Address: LEE & MORSE, P.C., 3141 FAIRVIEW PARK DRIVE, SUITE 500, FALLS CHURCH, VA, 22042, US

(21) Appl. No.: 12/222,496

(22) Filed: Aug. 11, 2008

(30) Foreign Application Priority Data
Aug. 22, 2007 (KR) 10-2007-0084498

(51) Int. Cl. H01J 17/49

(52) U.S. Cl. 313/582

(57) ABSTRACT

A PDP includes a first substrate and a second substrate facing the first substrate, a frit glass layer between the first and second substrates, the frit glass layer having a closed geometrical cross-section to define a sealed space between the first and second substrates, a plurality of electrodes on the first substrate and facing the second substrate, the electrodes including electrode terminals, and a common bar extending along an edge of the first substrate to electrically connect the electrode terminals, the common bar being positioned in a region not overlapping with the frit glass layer.

### BACKGROUND OF THE INVENTION

1. Field of the Invention

Embodiments of the present invention relate to a plasma display panel (PDP). More particularly, embodiments of the present invention relate to a PDP having an improved structure of a common bar on discharge electrodes thereof.

2. Description of the Related Art

A PDP may refer to a flat panel display device displaying, e.g., images, via a gas discharge phenomenon. For example, the PDP may include a discharge gas between two substrates, so application of a voltage, e.g., direct or alternate, via a plurality of discharge electrodes to the discharge gas may generate a discharge. The discharge may trigger ultraviolet (UV) light to excite phosphor layers to emit visible light.

The conventional PDP, e.g., a three-electrode surface discharge type PDP, may be subjected to an aging process for stabilizing characteristics of electrical components thereof. In the aging process, a conventional PDP may be driven at a higher voltage than a normal operational voltage for a predetermined period of time. For example, in a PDP including a discharge gas having less than about 7% of xenon (Xe) gas, the aging process may be performed by applying a low sustaining voltage Vs of about 150 V to about 250 V for about 10 hours to about 12 hours. In another example, in a PDP including a discharge gas having about 7% or more of Xe gas, the aging process may be performed by applying a high sustaining voltage of about 300 V to about 350 V for about 4 hours to about 6 hours.

Application of high sustaining voltage to the PDP during the aging process, however, may increase temperature of the PDP to a higher temperature than a normal operational temperature, thereby generating a large amount of heat therein. Further, a frit glass used to seal the substrates of the PDP together may slow down dissipation of heat generated during the aging process, thereby increasing an amount of heat further. A large amount of localized heat may trigger thermal stress, thereby causing damage to the PDP, e.g., forming cracks in the substrate of the PDP.

### SUMMARY OF THE INVENTION

Embodiments of the present invention are therefore directed to a PDP, which substantially overcomes one or more of the disadvantages and shortcomings of the related art.

It is therefore a feature of an embodiment of the present invention to provide a PDP having a common electrode bar structure capable of improving dissipation of heat during an aging process.

At least one of the above and other features and advantages of the present invention may be realized by providing a PDP, including a first substrate and a second substrate facing the first substrate, a frit glass layer between the first and second substrates, the frit glass layer having a closed geometrical cross-section in a horizontal plane to define a sealed space between the first and second substrates, a plurality of electrodes on the first substrate and facing the second substrate, the electrodes including electrode terminals, and a common bar extending along an edge of the first substrate to electrically connect the electrode terminals, the common bar being positioned in a region not overlapping with the frit glass layer. The common bar may be within the sealed space. The common bar may be outside the sealed space. The PDP may further include a silicon layer on the common bar.

The sealed space may be further defined by an overlap between the first and second substrates, the electrodes extending across the frit glass layer outside the sealed space to a region including no overlap of the first and second substrates, and the common bar being positioned inside the sealed space and being spaced apart from the frit glass layer. The sealed space may be defined by an overlap between the first and second substrates, the electrodes extending across the frit glass layer outside the sealed space to a region including no overlap of the first and second substrates, and the common bar being positioned outside the sealed space and being spaced apart from the frit glass layer. The PDP may further include a silicon layer on the common bar. The electrodes may be X electrodes disposed parallel to a long-side of the first substrate, and the common bar may be disposed parallel to a short-side of the first substrate. The common bar and the electrodes may include substantially same materials.

At least one of the above and other features and advantages of the present invention may be realized by providing a PDP, including a first substrate and a second substrate facing the first substrate, an overlap between the first and second substrates defining a display area and a region of the first substrate extending away from an edge of the display area defining a non-display area, a frit glass layer between the first and second substrates, the frit glass layer having an outer perimeter and an inner perimeter shorter than the outer perimeter, a plurality of electrodes on the first substrate and facing the second substrate, the electrodes being X electrodes and including discharge units in the display area and electrode terminals extending from the discharge units to the non-display area, a common bar extending along an edge of the first substrate to electrically connect the electrode terminals, the common bar being positioned in a region not overlapping the frit glass layer.

The common bar may be in the display area. The common bar may be between the inner boundary of the frit glass layer and a connection region of the discharge units and the electrode terminals. Each electrode terminal may include a connection unit in the non-display area and an inclined line unit connecting the connection unit to a respective discharge unit in the display area, the common bar intersecting the inclined line units. Adjacent connection units of the electrode terminals may have a smaller distance therebetween as compared to a distance between adjacent discharge units of the electrodes. The common bar may be in the non-display area. The common bar may be between the outer boundary of the frit glass and an outermost edge of the first substrate. The PDP may further include a silicon layer on the common bar.

### BRIEF DESCRIPTION OF THE DRAWINGS

The above and other features and advantages of the present invention will become more apparent to those of ordinary skill in the art by describing in detail exemplary embodiments thereof with reference to the attached drawings, in which:

FIG. 1 illustrates a partial, exploded perspective view of a PDP according to an embodiment of the present invention;

FIG. 2 illustrates an exploded perspective view of a plasma display apparatus having the PDP of FIG. 1;

FIG. 3 illustrates a schematic plan view of a connection between electrode terminals of the PDP of FIG. 1 and signal transmission units of FIG. 2;

FIG. 4 illustrates a magnified plan view of a configuration of a common electrode bar in a PDP according to an embodiment of the present invention; and

FIG. 5 illustrates a magnified plan view of a configuration of a common electrode bar in a PDP according to another embodiment of the present invention.

### DETAILED DESCRIPTION OF THE INVENTION

Korean Patent Application No. 10-2007-0084498, filed on Aug. 22, 2007, in the Korean Intellectual Property Office, and entitled: “Plasma Display Panel,” is incorporated by reference herein in its entirety.

Exemplary embodiments of the present invention will now be described more fully hereinafter with reference to the accompanying drawings, in which exemplary embodiments of the invention are illustrated. Aspects of the invention may, however, be embodied in different forms and should not be construed as limited to the embodiments set forth herein. Rather, these embodiments are provided so that this disclosure will be thorough and complete, and will fully convey the scope of the invention to those skilled in the art.

In the figures, the dimensions of layers and regions may be exaggerated for clarity of illustration. It will also be understood that when a layer or element is referred to as being “on” another layer or substrate, it can be directly on the other layer or substrate, or intervening layers or elements may also be present. Further, it will be understood that the term “on” can indicate solely a vertical arrangement of one element or layer with respect to another element or layer, and may not indicate a specific vertical orientation. In addition, it will also be understood that when a layer is referred to as being “between” two layers, it can be the only layer between the two layers, or one or more intervening layers may also be present. Like reference numerals refer to like elements throughout.

As used herein, the expressions “at least one,” “one or more,” and “and/or” are open-ended expressions that are both conjunctive and disjunctive in operation. For example, each of the expressions “at least one of A, B, and C,” “at least one of A, B, or C,” “one or more of A, B, and C,” “one or more of A, B, or C” and “A, B, and/or C” includes the following meanings: A alone; B alone; C alone; both A and B together; both A and C together; both B and C together; and all three of A, B, and C together. Further, these expressions are open-ended, unless expressly designated to the contrary by their combination with the term “consisting of.” For example, the expression “at least one of A, B, and C” may also include an nth member, where n is greater than 3, whereas the expression “at least one selected from the group consisting of A, B, and C” does not.

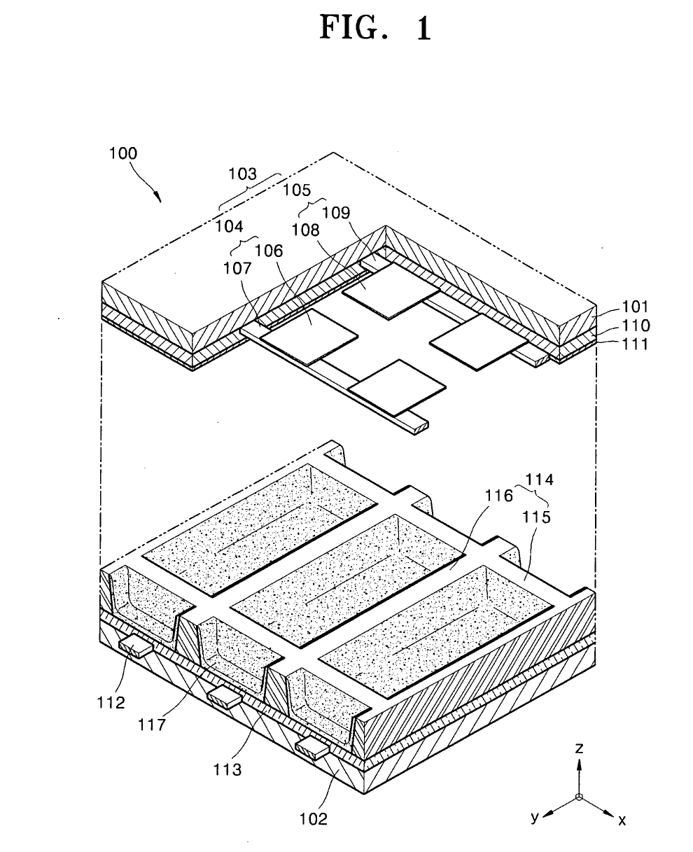

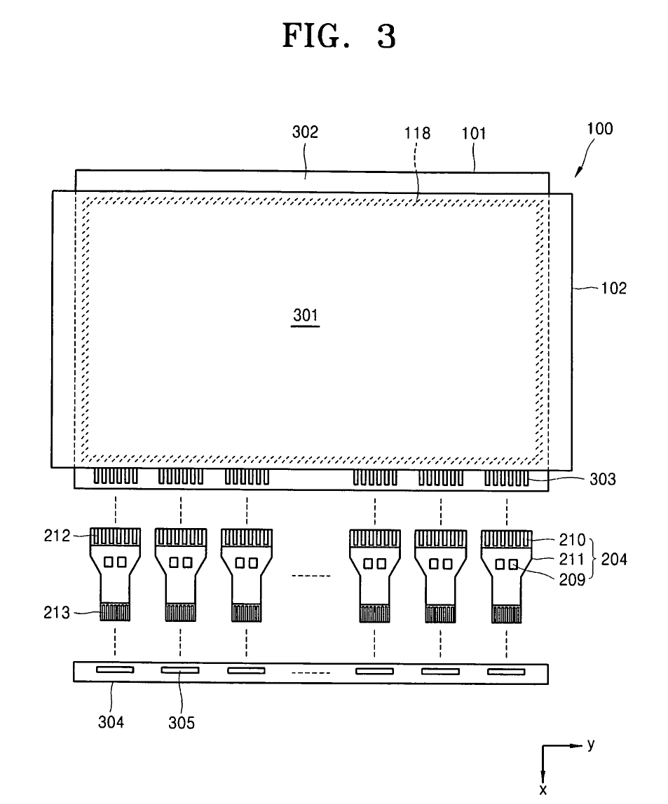

FIG. 1 illustrates a cut-away, exploded perspective view of PDP according to an embodiment of the present invention. Referring to FIG. 1, a PDP 100, e.g., a three-electrode surface discharge type PDP, may include a first substrate 101 and a second substrate 102 disposed parallel to the first substrate 101. Each one of the first and second substrates 101 and 102 may be any one of a transparent substrate, e.g., formed of soda lime glass, a semi-transparent substrate, a reflective substrate, or a colored substrate. A frit glass layer 118, as illustrated in FIG. 3, may be applied to peripheral areas of inner surfaces of the first and second substrates 101 and 102 to connect therebetween in order to form a sealed space between the first and second substrates 101 and 102. The sealed space, i.e., a display area 301 illustrated in FIG. 3, may include functional elements, e.g., pairs of sustain discharge electrodes 103 and discharge cells, and may provide display functions. In this respect, it is noted that “inner surface” may refer to a surface facing the sealed space.

The sustain discharge electrodes 103 of the PDP 100 may be in the display area 301, i.e., on an inner surface of the first substrate 101. As illustrated in FIG. 1, each pair of sustain discharge electrodes 103 may include an X electrode 104 and a Y electrode 105, so a pair of the X electrode 104 and the Y electrode 105 may be disposed along an array of discharge cells along the x-axis. Each X electrode 104 may include a first bus electrode line 107 corresponding to an array of discharge cells along the x-axis and a plurality of transparent electrodes 106 electrically connected to the first bus electrode line 107. Each transparent electrode 106 may be independently formed in each discharge cell in the array of discharge cells corresponding to the first bus electrode line 107. Each Y electrode 105 may include a plurality of second transparent electrodes 108 independently formed in each discharge cell and electrically connected to a second bus electrode line 109. The second bus electrode line 209 may be parallel to the first bus electrode line 207.

The first bus electrode line 107 and the second bus electrode line 109 may be positioned along edges of facing sides of the discharge cells, and may have an alternating stripe pattern. Accordingly, a pair of first and second transparent electrodes 106 and 108 may be positioned in each discharge cell along adjacent first and second bus electrode lines 107 and 109, such that the first and second transparent electrodes 106 and 108 may be spaced apart from each other at a predetermined interval. The predetermined interval may correspond to a center of each discharge cell in order to form a discharge gap.

The first transparent electrodes 106 and the second transparent electrodes 108 may have any suitable shape, e.g., a quadrangle. The first transparent electrodes 106 and the second transparent electrodes 108 may be formed of a transparent conductive film, e.g., indium tin oxide (ITO) film, and the first bus electrode line 107 and the second bus electrode line 109 may be formed of a metal material, e.g., silver (Ag) paste or chrome-copper-chrome (Cr—Cu—Cr).

The X electrode 104 and the Y electrode 105 may be buried by a first dielectric layer 110. The first dielectric layer 110 may be formed using a dielectric substance having high dielectric properties, e.g., a transparent dielectric. Examples of a transparent dielectric may include PbO—B₂O₃—SiO₂. A protective film layer 111 may be formed, e.g., of magnesium oxide (MgO), on a surface of the first dielectric layer 110 in order to increase emission of secondary electrons.

The PDP 100 may further include a plurality of address electrodes 112 on an inner surface, i.e., a surface facing the discharge cells, of the second substrate 102. The address electrodes 112, as illustrated in FIG. 1, may extend along respective arrays of discharge cells along the y-axis, i.e., each address electrode 112 may extend along a single array of discharge cells. The address electrodes 112 may cross the discharge electrodes 103, and may have a stripe pattern. The address electrodes 112 may be buried in a second dielectric layer 113 formed of, e.g., a substantially same material as the first dielectric layer 110.

The PDP 100 may further include a barrier rib structure 114, as illustrated in FIG. 1, between the first substrate 101 and the second substrate 102. The barrier rib structure 114 may define the discharge cells, and may prevent cross-talk between the discharge cells. The barrier rib structure 114 may include first barrier ribs 115 along the x-axis and second barrier ribs 116 along the y-axis, such that the first barrier ribs 115 may connect the second barrier ribs 116 to each other to form a matrix pattern of discharge spaces having any suitable cross-section, e.g., a polygon, a quadrangle, a circle, an oval, and so froth. Discharge gas, e.g., neon (Ne), xenon (Xe), helium (He), or a combination thereof, may be injected into the discharge cells defined by the first substrate 101, the second substrate 102, and the barrier rib structure 114.

The PDP 100 may further include phosphor layers 117 to emit visible light when excited by UV light generated by the discharge gas, so a plurality of colors may be emitted from the discharge cells to realize a colored image. The phosphor layer 117 may be formed in any region of the discharge cell, e.g., on an inner surface of the second dielectric layer 113 and/or on sidewalls of the barrier ribs 214. The phosphor layers 117 may include red phosphor, e.g., (Y,Gd)BO₃;Eu⁺³, green phosphor, e.g., Zn₂SiO₄:Mn³⁺, and/or blue phosphor, e.g., BaMgAl₁₀O₁₇:Eu²⁺. Accordingly, after selecting the discharge cells by applying an electrical signal to the Y electrodes 105 and the address electrodes 112 of the discharge cells to be selected, UV light may be generated in the discharge cells, e.g., on a surface of the first substrate 101, by alternately applying an electrical signal to the X and Y electrodes 104 and 105. The UV light may excite the phosphor layers 117 to emit visible light, so a stationary image or a moving image may be realized using the visible light emitted from the selected discharge cells.

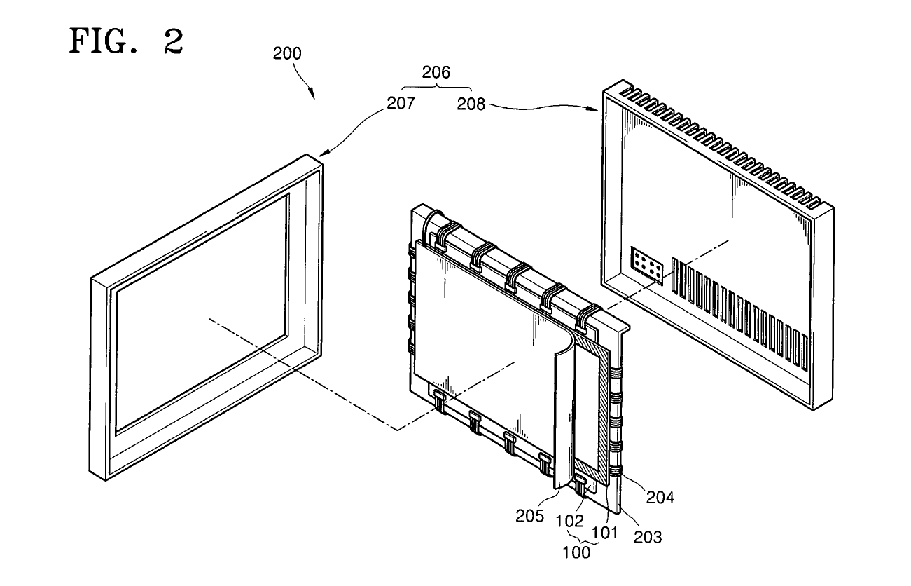

FIG. 2 illustrates an exploded perspective view of a plasma display apparatus 200 having the PDP 100 of FIG. 1. Referring to FIG. 2, the plasma display apparatus 200 may include the PDP 100, a chassis base assembly 203 attached to a rear surface of the PDP 100, a filter assembly 205 attached to a front surface of the PDP 100, and a case 206 to accommodate the PDP 100, the chassis base assembly 203, and the filter assembly 205. The case 206 may include a front cabinet 207 installed in front of the filter assembly 205 and a back cover 208 installed on a rear of the chassis base assembly 203. The filter assembly 205 may include a plurality of filters in order to block reflection of external light and/or emission of electromagnetic waves, UV light, and/or neon light generated during operation of the PDP 100. The plasma display apparatus 200 may further include signal transmission units 204, e.g., flexible printed cables (FPCs), to transmit electrical signals between circuit boards 304 on the chassis base assembly 203 (FIG. 3) to the PDP 100.

FIG. 3 illustrates a schematic plan view of a connection between electrode terminal units 303 in the PDP 100 and the signal transmission units 204. The first and second substrates 101 and 102 may have different lengths, e.g., along the x-axis. For example, referring to FIG. 3, the first substrate 101 may be longer than the second substrate 102 along the x-axis. Accordingly, the display area 301 may include only an area formed by an overlap of the first and second substrates 101 and 102. Portions of the first substrate 101 extending, e.g., along the x-axis, beyond the second substrate 102 may be referred to as a non-display area 302, and may include the electrode terminals 303 of the discharge electrodes 103 or of the address electrodes 112. The non-display area 302 may be a peripheral area on a longer substrate along at least one edge of the display area 301 to expose the electrode terminals 303. In other words, the non-display area 302 may include portions of the first substrate 101 not overlapping with the second substrate 102 or portions of the second substrate 102 not overlapping with the first substrate 101. The PDP 100 may include a plurality of non-display areas 302, e.g., the first substrate 101 may extend beyond more than a single edge of the second substrate 102. The frit glass 118, illustrated in FIG. 3, may be coated between the first and second substrates 101 and 102 to define a boundary between the display area 301 and the non-display area 302, and may have any suitable closed geometrical cross-section in a horizontal plane, e.g., a rectangular cross-section in the xy-plane, to facilitate formation of the sealed space in the display area 301.

As described previously, the display area 301 may define a region for forming functional elements, e.g., the discharge electrodes 103, the first and second dielectric layers 110 and 113, the first and second barrier ribs 115 and 116, and the phosphor layers 117, on inner surfaces of the first substrate 101 and the second substrate 102. Accordingly, an image may be realized in the display area 301 when a discharge is generated in the discharge cells. The non-display area 302 may provide a region for connecting the electrode terminals 303 to respective signal transmission units 204.

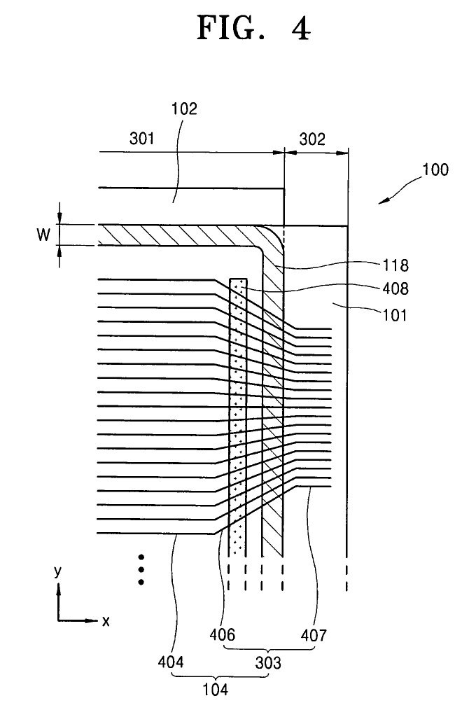

The electrode terminals 303 may be integral with the electrodes, e.g., discharge electrodes 103, and may extend on respective substrate, e.g., the first substrate 101, in a stripe-pattern in at least one non-display area 302. For example, the electrode terminals 303 may be electrode terminals of the X electrodes 104 extending along the x-axis on the first substrate 101 on at least one of a short-side or a long-side of the PDP 100 according to any suitable method of patterning discharge electrodes, as will be explained in more detail below with reference to FIG. 4.

The electrode terminals 303 may be configured in groups. In other words, the electrode terminals 303 may be arranged into a plurality of groups spaced apart from each other, each group having a plurality of electrode terminals 303, as illustrated in FIG. 3. A single group of electrode terminals 303 may be separately connected to a single signal transmission unit 204. Accordingly, a large size of the PDP 100 may require a plurality of signal transmission units 204 connected to a plurality of electrode terminals 303 arranged into a plurality of groups. The electrode terminals 303 may not be covered by the second dielectric layer 113 and/or by the first dielectric layer 110 to facilitate electrical connection between the electrode terminals 303 and the signal transmission units 204. It is noted that other configurations, e.g., all the electrode terminal units 303 may be connected via a single large signal transmission unit, are within the scope of the present invention.

The signal transmission units 204 of the plasma display apparatus 200 may be formed in any suitable shape, and may be connected to the electrode terminals 303, as illustrated in FIG. 3, to drive the PDP 100. More specifically, each signal transmission unit 204 may be connected between a group of electrode terminals 303 and a corresponding circuit terminal unit 305 of the circuit board 304 to transmit electrical signals between the electrode terminals 303, i.e., the PDP 100, and the circuit board 304. Each signal transmission unit 204 may include a plurality of integrated circuits (ICs) 209, a lead 210 patterned to be connected to the ICs 209, and a flexible film 211 to entirely cover the lead 210 except for a portion where both ends of the lead 210 are respectively connected to the electrode terminal 303 and to the circuit terminal units 305. In particular, the lead 210 may be electrically connected to the electrode terminals 303 via first lead terminals 212 formed at a first edge of the lead 210, and may be electrically connected to the circuit terminal unit 305 via second terminals 213 formed at a second edge of the lead 210, i.e., an edge opposite the first edge.

According to embodiments of the present embodiment, the electrode terminals 303 may be connected to each other by a common bar 408 configured in a region not overlapping the frit glass 118. Configuration of the common bar 408 with respect to the electrode terminal 303 will be described in more detail below with reference to FIG. 4.

FIG. 4 illustrates a magnified plan view of a connection between the common bar 408 and the X electrodes 104 according to an embodiment of the present invention. It is noted that even though the electrode terminals 303 are illustrated in FIG. 4 as terminals of the X electrodes 104, similar configurations of terminals of other electrodes are within the scope of the present invention, and the X electrodes 104 are illustrated in FIG. 4 for convenience only.

Referring to FIG. 4, an enlarged portion of the PDP 100 illustrates the display area 301, i.e., a region including the overlap between the first and second substrates 101 and 102, and the non-display area 302, i.e., a region-exposing an inner surface of the first substrate 101, extending from an edge of the display area 301 along the x-axis. It is noted that the non-display area 302 may also include an exposed portion of an inner surface of the second substrate 102 along the y-axis (not illustrated). As described previously with reference to FIGS. 1 and 3, the display area 301 may define a region where an image is displayed, and the non-display area 302 may define a region where the X electrodes 104 are connected to the signal transmission units 204. As further described previously with reference to FIGS. 1 and 3, the frit glass 118 may be coated along edges of the display area 301 to connect the first and second substrates 101 and 102 and to form a boundary between the display area 301 and the non-display area 302, i.e., to completely seal the display area 301 from the outside.

For example, the frit glass 118 may be coated on a boundary where the first substrate 101 overlaps the second substrate 102, and may also be coated on inner sides of the boundary. In other words, as illustrated in FIG. 4, the frit glass 118 may have a predetermined width W within the display area 301, e.g., a distance between outer and inner perimeters of the frit glass 118. For example, an outer perimeter of the frit glass 118, i.e., an outermost edge of the frit glass 118, may define an outermost edge of the display area 301, so the width W of the frit glass 118 may be measured from the outermost edge of the frit glass 118 toward a center of the display area 301 along a normal to the outer perimeter of the frit glass 118. It is noted that coating of the frit glass 118 is not limited to any one region, as long as the frit glass 118 may be coated on the boundary between the display area 301 and the non-display area 302.

The X electrodes 104 may be disposed parallel to each other along the x-axis on an inner surface of the first substrate 101. Each X electrodes 104 may include a discharge unit 404 patterned in the display area 301 and a respective electrode terminal extending from the discharge unit 404 in the display region 301 to the non-display area 302. The discharge units 404 may be disposed in parallel to each other, and may have distances therebetween along the y-axis. The electrode terminals 303 may be connected to the discharge units 404, e.g., the electrode terminals 303 may be integral with the discharge units 404, and may include a connection unit 407 positioned in the non-display area 302 and an inclined line unit 406 connecting the connection unit 407 to a respective discharge unit 404. The connection units 407 may be exposed to the outside on the non-display area 302.

The connection units 407 may be disposed along the x-axis, and may be spaced apart from each along the y-axis. Distances between adjacent connection units 407 may be smaller than distances between adjacent discharge units 404, so a width of a group of connection units 407, i.e., a distance as measured along the y-axis between a first connection unit 407 in a group of connection units 407 to a last connection unit 407 in a group of connection units 407, may be smaller than a width of a group of discharge units 404, i.e., a distance as measured along the y-axis between a first discharge unit 404 in a group of discharge units 404 to a last discharge unit 404 in a group of discharge units 404. The relatively small width of a group of connection units 407 may facilitate connection thereof with first terminals 211 of a respective signal transmitting unit 204. Accordingly, the inclined line units 406 connecting the discharge units 404 to the connection units 407 may be obliquely disposed at a predetermined angle. The inclined line units 406 may extend on the inner surface of the first substrate 101 between the display area 301 and the non-display area 302 across the frit glass 118.

The common bar 408 may be connected to all the X electrodes 104 in order to commonly apply a discharge voltage to the X electrodes 104. For convenience of manufacturing, the common bar 408 may be formed of a substantially same material as the X electrodes 104, e.g., Ag paste or Cr—C—Cr. The common bar 408 may extend along the y-axis, and may be positioned in a region not overlapping with the frit glass 118. The common bar 408 may be positioned in the display area 301. For example, as illustrated in FIG. 4, the common bar 408 may be positioned between the frit glass 118, i.e., the inner perimeter of the frit glass 118, and the discharge unit 404 of the X electrodes 104, e.g., the common bar may intersect the inclined line units 406 of the electrode terminals 303. For example, as further illustrated in FIG. 4, the common bar 408 may be spaced apart from an inner edge, i.e., the inner perimeter, of the frit glass 118 along the x-axis.

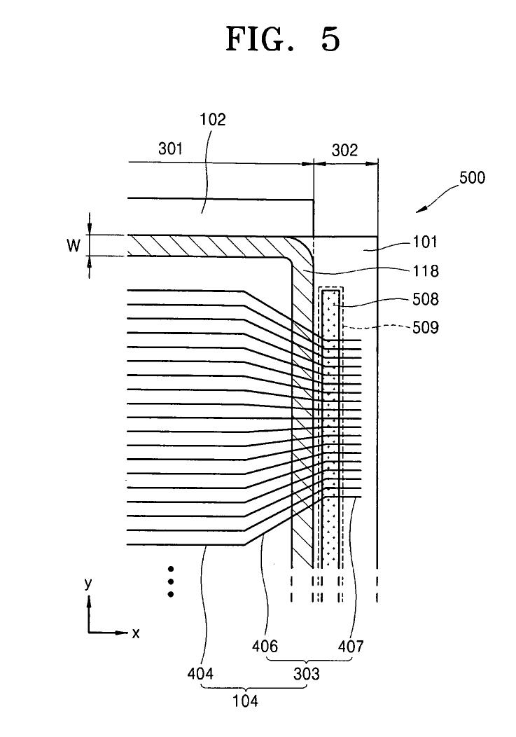

FIG. 5 illustrates a magnified plan view of a connection between a common bar 508 and the X electrodes 104 according to another embodiment of the present invention. Referring to FIG. 5, a PDP 500 may be substantially similar to the PDP 100 described previously with reference to FIGS. 1-4, with the exception of the position of the common bar 508. In particular, the common bar 508 may extend along the y-axis in the non-display area 302.

The common bar 508 may be connected to all the X electrodes 104 in order to commonly apply a discharge voltage to the X electrodes 104. For convenience of manufacturing, the common bar 508 may be formed of a substantially same material as the X electrodes 104, e.g., Ag paste or Cr—Cu—Cr. The common bar 508 may not overlap the frit glass 118. In other words, the common bar 508 may be positioned between the outer perimeter of the frit glass 118 and an outermost edge of the first substrate 101. For example, as illustrated in FIG. 5, the common bar 508 may intersect the connection units 407 of the electrode terminals 303 in the non-display area 302. As further illustrated in FIG. 5, the common bar 508 may be spaced apart from the outer edge of the frit glass 118 along the x-axis.

Positioning of the common bar 508 in the non-display area 302 may expose the common bar 508 to an outside, so dissipation of heat from the common bar 508 may be facilitated. A silicon layer 509 may be coated on the common bar 508, e.g., on a region where the common bar 508 is connected to the terminal units 407 of the electrode terminals 303. For example, surfaces of the common bar 508 exposed to the outside may be coated with the silicon layer 509 in order to protect the common bar 508.

### EXAMPLE

A PDP manufactured according to an embodiment of the present invention, i.e., Example 1, was compared to a conventional PDP, i.e., Comparative Example 1. The conventional PDP was manufactured according to a substantially same method as the PDP of Example 1, with the exception of overlapping a common bar with a portion of a frit glass. X electrode terminals of each PDP were subjected to an increased temperature, and a response of each substrate according to the increasing temperature of the X electrode terminals, i.e., thermal stress, was observed. Results are reported in Table 1 below.

TABLE 1

| | Comparative Example 1 | Example 1 |
|---|---|---|
| Failure Rate of Substrate due to | 2.8% | 0.21% |
| Temperature Increase | | |

Referring to Table 1, the failure rate of the substrate of the conventional PDP was approximately 2.8%, while the failure rate of the substrate of the PDP according to embodiments of the present invention was approximately 0.21%. Thus, the substrate in the PDP of Example 1, i.e., a PDP according to embodiments of the present invention, exhibited a reduction of about 2.59% in substrate failure rate, i.e., damage, due to temperature increase at the electrode terminals.

In other words, an overlap between the frit glass and the common bar in the conventional PDP decreased dissipation of heat from the electrode terminals. As such, heat generated around the electrode terminals during the aging did not dissipate efficiently and caused rapid temperature increase in a predetermined localized region. The temperature increase lead to failure of the substrate, e.g., cracks in the substrate, and overall damage to the conventional PDP. Accordingly, from the results reported in Table 1, it can be seen that PDPs according to embodiments of the present invention may be advantageous in providing a common bar for the X electrodes in regions not overlapping with the frit glass, thereby facilitating smooth heat dissipation through heat convection during aging. Thus, breakage of the substrate due to a temperature increase may be substantially minimized or prevented.

As described above, a PDP according to embodiments of the present invention may be advantageous in providing a common bar for connecting electrode terminals, e.g., terminals of X electrodes, in a region not overlapping with a frit glass, i.e., in a region not overlapping an area where a frit glass is formed on inner surfaces of and between first and second substrates. Thus, heat convection in a connection region between the electrode terminals and common bar may be performed smoothly with increased efficiency during aging, thereby preventing or substantially minimizing substrate damage and/or breakage due to high temperature.

Exemplary embodiments of the present invention have been disclosed herein, and although specific terms are employed, they are used and are to be interpreted in a generic and descriptive sense only and not for purpose of limitation. Accordingly, it will be understood by those of ordinary skill in the art that various changes in form and details may be made without departing from the spirit and scope of the present invention as set forth in the following claims.

What is claimed is:

1. A plasma display panel (PDP), comprising:
a first substrate and a second substrate facing the first substrate;
a frit glass layer between the first and second substrates, the frit glass layer having a closed geometrical cross-section in a horizontal plane to define a sealed space between the first and second substrates;
a plurality of electrodes on the first substrate and facing the second substrate, the electrodes including electrode terminals; and
a common bar extending along an edge of the first substrate to electrically connect the electrode terminals, the common bar being positioned in a region not overlapping with the frit glass layer.

2. The PDP as claimed in claim 1, wherein the common bar is within the sealed space.

3. The PDP as claimed in claim 1, wherein the common bar is outside the sealed space.

4. The PDP as claimed in claim 3, further comprising a silicon layer on the common bar.

5. The PDP as claimed in claim 1, wherein the sealed space is further defined by an overlap between the first and second substrates, the electrodes extending across the frit glass layer outside the sealed space to a region including no overlap of the first and second substrates, and the common bar being positioned inside the sealed space and being spaced apart from the frit glass layer.

6. The PDP as claimed in claim 1, wherein the sealed space is defined by an overlap between the first and second substrates, the electrodes extending across the frit glass layer outside the sealed space to a region including no overlap of the first and second substrates, and the common bar being positioned outside the sealed space and being spaced apart from the frit glass layer.

7. The PDP as claimed in claim 6, further comprising a silicon layer on the common bar.

8. The PDP as claimed in claim 1, wherein the electrodes are X electrodes disposed parallel to a long-side of the first substrate and the common bar is disposed parallel to a short-side of the first substrate.

9. The PDP as claimed in claim 1, wherein the common bar and the electrodes include substantially same materials.

10. A plasma display panel (PDP), comprising:
a first substrate and a second substrate facing the first substrate, an overlap between the first and second substrates defining a display area and a region of the first substrate extending away from an edge of the display area defining a non-display area;
a frit glass layer between the first and second substrates, the frit glass layer having an outer perimeter and an inner perimeter shorter than the outer perimeter;
a plurality of electrodes on the first substrate and facing the second substrate, the electrodes being X electrodes and including discharge units in the display area and electrode terminals extending from the discharge units to the non-display area;
a common bar extending along an edge of the first substrate to electrically connect the electrode terminals, the common bar being positioned in a region not overlapping the frit glass layer.

11. The PDP as claimed in claim 10, wherein the common bar is in the display area.

12. The PDP as claimed in claim 11, wherein the common bar is between the inner boundary of the frit glass layer and a connection region of the discharge units and the electrode terminals.

13. The PDP as claimed in claim 12, wherein each electrode terminal includes a connection unit in the non-display area and an inclined line unit connecting the connection unit to a respective discharge unit in the display area, the common bar intersecting the inclined line units.

14. The PDP as claimed in claim 13, wherein adjacent connection units of the electrode terminals have a smaller distance therebetween as compared to a distance between adjacent discharge units of the electrodes.

15. The PDP as claimed in claim 10, wherein the common bar is in the non-display area.

16. The PDP as claimed in claim 15, wherein the common bar is between the outer boundary of the frit glass and an outermost edge of the first substrate.

17. The PDP as claimed in claim 16, further comprising a silicon layer on the common bar.
